(19) United States
(12) Patent Application Publication
(10) Pub. No.: US 2025/0372313 A1
(43) Pub. Date: Dec. 4, 2025

(54) CAPACITOR

(71) Applicant: Panasonic Intellectual Property Management Co., Ltd., Osaka (JP)

(72) Inventors: MASANOBU SHIMA, Toyama (JP); ERIKO KANATANI, Toyama (JP)

(21) Appl. No.: 19/211,348

(22) Filed: May 19, 2025

(30) Foreign Application Priority Data
Jun. 3, 2024 (JP) 2024-090150

(51) Int. Cl. H01G 4/38; H01G 4/258

(52) U.S. Cl. CPC H01G 4/38; H01G 4/258

(57) ABSTRACT

A capacitor includes a plurality of capacitor elements aligned in a first direction, a first bus bar, and a second bus bar. Each of the plurality of capacitor elements includes an element body, a first electrode, and a second electrode. The first bus bar includes a first internal terminal connected to the first electrode, a first external terminal, and a first connecting part that connects the first internal terminal with the first external terminal. The first connecting part includes a side plate positioned at a side of the plurality of capacitor elements in a second direction orthogonal to the first direction. A capacitor element disposed at a position farthest from the first external terminal in the first direction among the plurality of capacitor elements is disposed at a position closest to the side plate of the first connecting part in the second direction.

### BACKGROUND

### 1. Technical Field

The present disclosure relates generally to a capacitor, and more specifically to a capacitor including a plurality of capacitor elements.

### 2. Description of the Related Art

Unexamined Japanese Patent Publication No. 2018-007325 discloses a power conversion device. The power conversion device includes a plurality of semiconductor switching elements, a reactor, a low-voltage capacitor, a high-voltage capacitor, a charge and discharge capacitor, and a controller that controls driving of the plurality of semiconductor switching elements at a predetermined driving frequency.

### SUMMARY

A capacitor according to one aspect of the present disclosure includes a plurality of capacitor elements aligned in a first direction, a first bus bar, and a second bus bar. Each of the plurality of capacitor elements includes an element body, a first electrode disposed at one end of the element body, and a second electrode disposed at another end of the element body. The first bus bar includes a first internal terminal connected to the first electrode, a first external terminal to be connected to an external device, and a first connecting part that connects the first internal terminal with the first external terminal. The first connecting part extends in the first direction. The first connecting part includes a side plate positioned at a side of the plurality of capacitor elements in a second direction orthogonal to the first direction. The second bus bar includes a second internal terminal connected to the second electrode, a second external terminal to be connected to the external device, and a second connecting part that connects the second internal terminal with the second external terminal. A capacitor element disposed at a position farthest from the first external terminal in the first direction among the plurality of capacitor elements is disposed at a position closest to the side plate of the first connecting part in the second direction among the plurality of capacitor elements.

According to the present disclosure, the variations in heat generation of the plurality of capacitor elements can be reduced.

### BRIEF DESCRIPTION OF THE DRAWINGS

FIG. 1 is a perspective view illustrating a capacitor according to a first exemplary embodiment;

FIG. 2 is a perspective view illustrating a capacitor (however, a case and a seal portion are excluded) according to the first exemplary embodiment;

FIG. 3 is an exploded perspective view illustrating the capacitor according to the first exemplary embodiment;

FIG. 4 is a plan view illustrating the capacitor according to the first exemplary embodiment;

FIG. 5 is a bottom view illustrating the capacitor according to the first exemplary embodiment;

FIG. 6 is a perspective view illustrating a capacitor according to a second exemplary embodiment;

FIG. 7 is an exploded perspective view illustrating the capacitor according to the second exemplary embodiment;

FIG. 8 is a plan view illustrating the capacitor according to the second exemplary embodiment;

FIG. 9 is a bottom view illustrating the capacitor according to the second exemplary embodiment;

FIG. 10 is a perspective view illustrating a capacitor according to a third exemplary embodiment;

FIG. 11 is an exploded perspective view illustrating the capacitor according to the third exemplary embodiment;

FIG. 12 is a plan view illustrating the capacitor according to the third exemplary embodiment; and

FIG. 13 is a bottom view illustrating the capacitor according to the third exemplary embodiment.

### DETAILED DESCRIPTIONS OF EMBODIMENTS

The problems in the conventional technology are briefly described below.

In the power conversion device of Unexamined Japanese Patent Publication No. 2018-007325, the charge and discharge capacitor is formed by connecting a plurality of capacitor elements in parallel by first and second wirings. Thus, there is a problem that variations in heat generation of the plurality of capacitor elements easily occur.

The present disclosure provides a capacitor capable of reducing variations in heat generation of a plurality of capacitor elements.

### 1. Overview

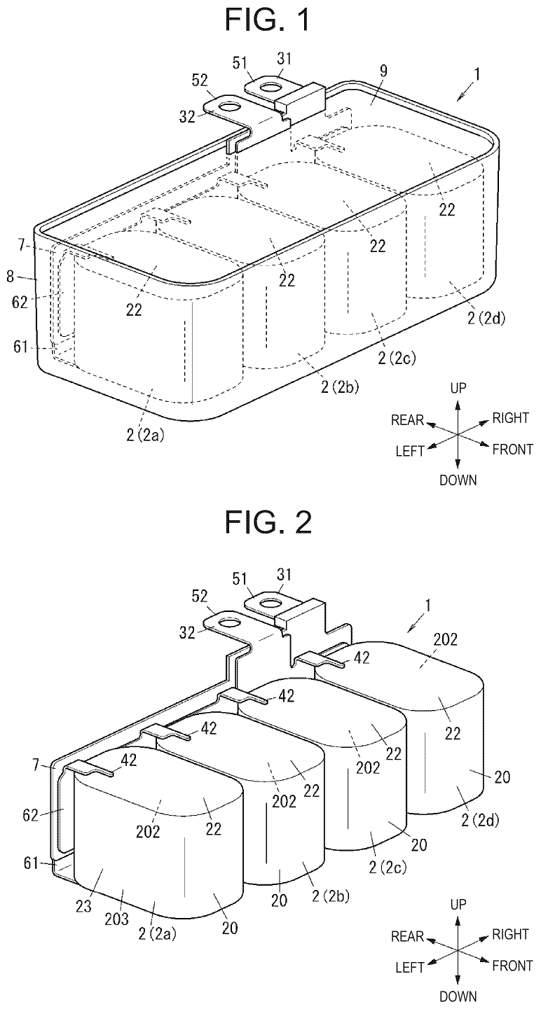

As illustrated in FIGS. 1 to 5, capacitor 1 according to the present exemplary embodiment includes a plurality of capacitor elements 2 aligned in one direction (left-right direction), first bus bar 31, and second bus bar 32.

A distance (current path) between each capacitor element 2 and first external terminal 51 of first bus bar 31 differs depending on a position of capacitor element 2. For example, the current path between first capacitor element 2a and first external terminal 51 is the longest, and the current path between fourth capacitor element 2d and first external terminal 51 is the shortest.

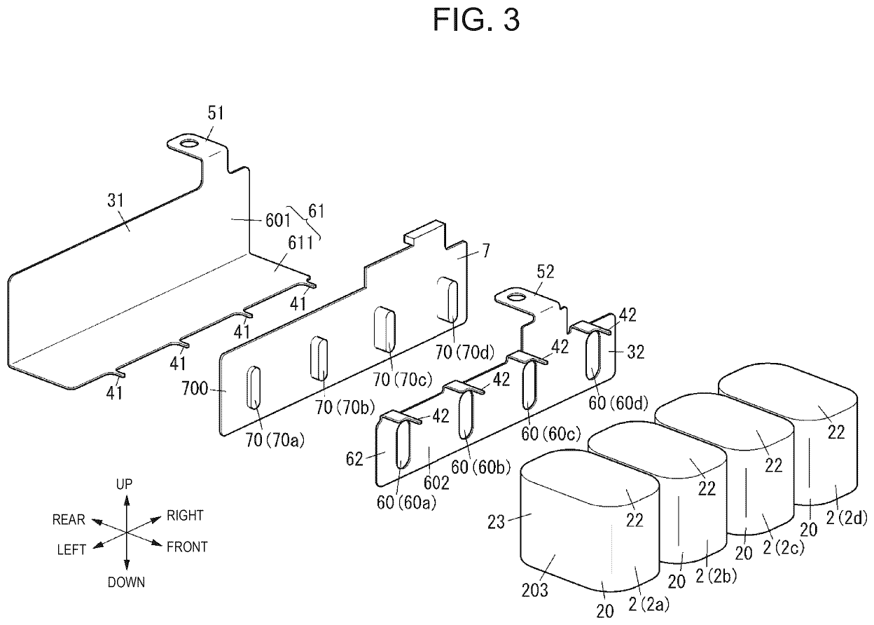

When a distance between side plate 601 (see FIG. 3) of first connecting part 61 of first bus bar 31 and capacitor elements 2 is uniform for all capacitor elements 2, a resonance frequency derived from an electrostatic capacity of capacitor element 2 and an inductance of the current path for capacitor element 2 may not match in all capacitor elements 2. As a result, variations in heat generation of the plurality of capacitor elements 2 easily occur.

In the present exemplary embodiment, capacitor element 2 (first capacitor element 2a) farthest from first external terminal 51 among the plurality of capacitor elements 2 is disposed at a position closest to side plate 601 of first connecting part 61. Thus, a magnetic flux generated by a current flowing through first capacitor element 2a and a magnetic flux generated by a current flowing through side plate 601 of first connecting part 61 cancel each other. Thus, the inductances of all the current paths of the plurality of capacitor elements 2 can be easily matched.

As a result, the resonance frequency derived from the electrostatic capacity of capacitor element 2 and the inductance of the current path for capacitor element 2 can be matched in the plurality of capacitor elements 2. As a result, since a difference in impedance and phase is hardly generated in the entire frequency range, it is possible to suppress variation in current divided and flowing through each capacitor element 2.

Accordingly, according to the present exemplary embodiment, the variations in heat generation of the plurality of capacitor elements 2 can be reduced.

### 2. Details

### (1) First Exemplary Embodiment

Hereinafter, capacitor 1 according to a first exemplary embodiment will be described with reference to FIGS. 1 to 5. Each drawing is a schematic view, and a ratio of a size and a thickness of each configuration elements in each drawing does not necessarily reflect an actual dimensional ratio.

An arrow indicating each direction in each drawing is not intended to define a direction of capacitor 1 at the time of use, but is merely written for easy understanding of the description, and is not accompanied by entity.

An up-down direction is a direction linking first electrode 21 and second electrode 22 of capacitor element 2. A side close to second electrode 22 is referred to as “up”, and a side close to first electrode 21 is referred to as “down”. Viewing along the up-down direction may be referred to as “plan view”.

A left-right direction is a direction in which the plurality of capacitor elements 2 are aligned. Viewing along the left-right direction may be referred to as “side view”.

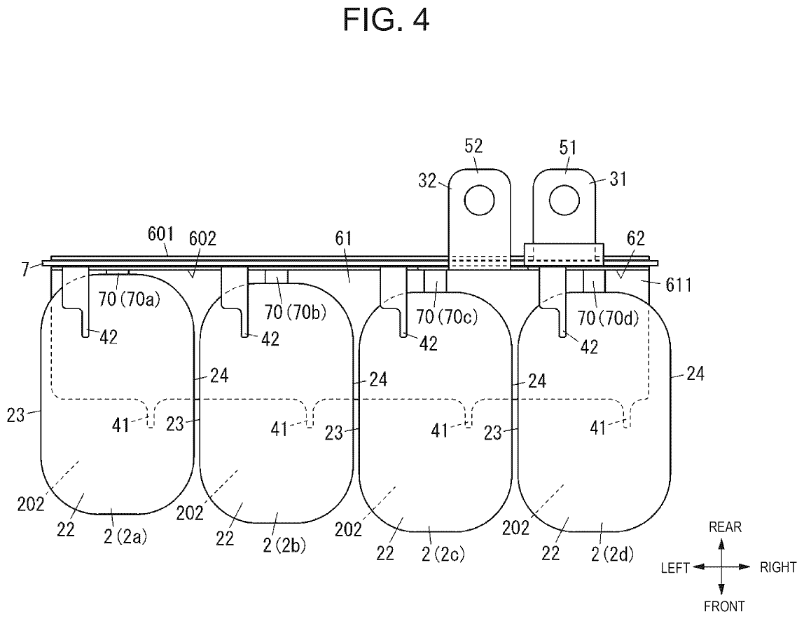

A front-rear direction is a direction in which capacitor element 2 and side plate 601 of first connecting part 61 of first bus bar 31 are aligned (see FIG. 4). A side close to capacitor element 2 is referred to as “front”, and a side close to side plate 601 is referred to as “rear”. Viewing along the front-rear direction may be referred to as “front view”.

As illustrated in FIG. 2, capacitor 1 according to the first exemplary embodiment includes the plurality of capacitor elements 2, first bus bar 31, and second bus bar 32. Capacitor 1 may further include insulating member 7. As illustrated in FIG. 1, capacitor 1 may further include case 8 and seal portion 9. Hereinafter, the configuration elements will be described in order.

### <Capacitor Element>

The plurality of (four in the present exemplary embodiment) capacitor elements 2 are aligned in a first direction (left-right direction). In a case where four capacitor elements 2 are distinguished from each other, capacitor elements 2 may be referred to as first capacitor element 2a, second capacitor element 2b, third capacitor element 2c, and fourth capacitor element 2d in order from left to right.

Capacitor element 2 is a main component of capacitor 1. Capacitor element 2 is not particularly limited, and examples thereof include a wound capacitor element and a layered capacitor element.

Specifically, capacitor element 2 includes element body 20, first electrode 21, and second electrode 22.

### «Element Body»

Element body 20 has a rounded rectangular shape in plan view, and a rectangular shape in front view and side view. Meanwhile, a shape of element body 20 is not particularly limited. Examples of the shape of element body 20 include a columnar shape, an elliptical columnar shape, and a rectangular parallelepiped shape.

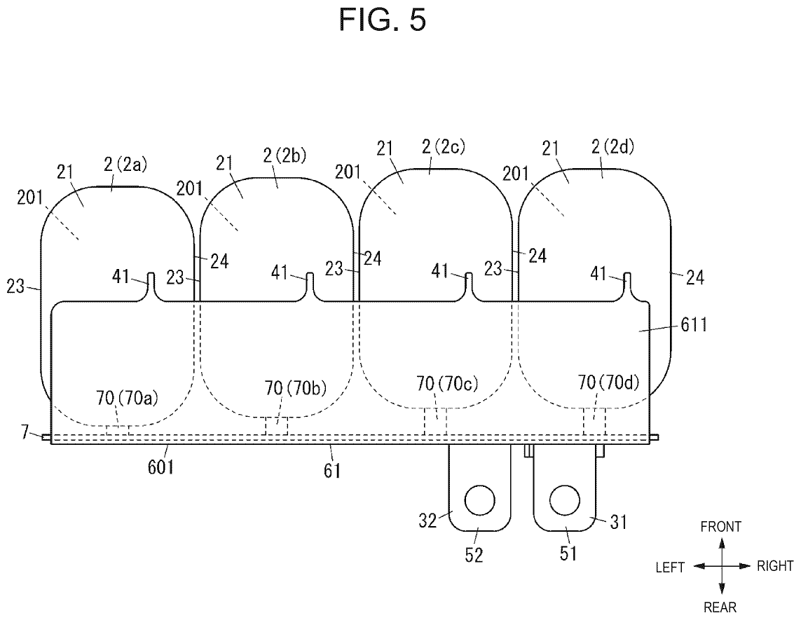

Element body 20 has first end surface 201, second end surface 202, and outer peripheral surface 203. First end surface 201 is a lower surface and has a rounded rectangular shape in plan view (see FIG. 5). Second end surface 202 is an upper surface and has a rounded rectangle in plan view similarly to first end surface 201 (see FIG. 4). Outer peripheral surface 203 is a surface connecting an outer peripheral edge of first end surface 201 and an outer peripheral edge of second end surface 202 (see FIG. 2). Outer peripheral surface 203 has flat surface 23 and flat surface 24. Flat surface 23 is a flat surface facing a left side, and flat surface 24 is a flat surface facing a right side (see FIGS. 4 and 5). As described above, element body 20 includes two flat surfaces 23 and 24 parallel to each other.

Element body 20 includes a dielectric film, a first internal electrode, and a second internal electrode. In an inside of element body 20, the first internal electrode and the second internal electrode face each other with the dielectric film interposed therebetween. The first internal electrode and the second internal electrode are deposited on the dielectric film. As described above, capacitor 1 is a film capacitor. Note that, illustrations of the first internal electrode and the second internal electrode are omitted.

The material of the dielectric film is not particularly limited, and examples thereof include polypropylene (PP), polyethylene terephthalate (PET), polyethylene naphthalate (PEN), polyphenylene sulfide (PPS), polycarbonate (PC), and polystyrene (PS). Outer peripheral surface 203 of element body 20 may be made of a dielectric film, or may be made of a member having an electrical insulation property other than the dielectric film.

Part of the first internal electrode is exposed on first end surface 201 of element body 20 and is not exposed on second end surface 202. On the other hand, a part of the second internal electrode is exposed on second end surface 202 of element body 20, and is not exposed on first end surface 201. Materials of the first internal electrode and the second internal electrode are not particularly limited, and examples thereof include aluminum (Al), gold (Au), magnesium (Mg), zinc (Zn), tin (Sn), nickel (Ni), chromium (Cr), iron (Fe), copper (Cu), titanium (Ti), and alloys thereof.

### «First Electrode»

First electrode 21 is disposed at one end of element body 20 (see FIG. 5). Specifically, first electrode 21 is disposed on first end surface 201 of element body 20.

First electrode 21 is formed by spraying metal on first end surface 201 of element body 20. As a result, first electrode 21 is electrically connected to the first internal electrode. The metal forming first electrode 21 is not particularly limited, and examples thereof include zinc (Zn), tin (Sn), and alloys thereof.

### «Second Electrode»

Second electrode 22 is disposed at the other end of element body 20 (see FIG. 4). Specifically, second electrode 22 is disposed on second end surface 202 of element body 20.

Second electrode 22 is formed by spraying metal on second end surface 202 of element body 20. As a result, second electrode 22 is electrically connected to the second internal electrode. The metal forming second electrode 22 is similar to the metal forming first electrode 21.

### <First Bus Bar>

First bus bar 31 is a conductive member. A material of first bus bar 31 is not particularly limited, and examples thereof include copper (Cu), aluminum (Al), and alloys thereof.

As illustrated in FIG. 3, first bus bar 31 includes first internal terminals 41, first external terminal 51, and first connecting part 61. First internal terminals 41, first external terminal 51, and first connecting part 61 are integrated. First bus bar 31 is formed by, for example, appropriately punching and bending a metal plate.

### «First Internal Terminal»

First internal terminals 41 have a one-to-one correspondence with capacitor elements 2. That is, in first bus bar 31, a number of first internal terminals 41 is equal to a number of capacitor elements 2. First internal terminals 41 protrude forward from first connecting part 61. First internal terminals 41 are connected to first electrodes 21 by, for example, soldering (see FIG. 5).

### «First External Terminal»

First external terminal 51 is configured to be connected to an external device (not illustrated). The external device is not particularly limited, and examples thereof include components constituting an inverter device. That is, capacitor 1 can be a part of the inverter device, for example.

First external terminal 51 is disposed at a position closest to fourth capacitor element 2d (see FIGS. 4 and 5). Further, first external terminal 51 is disposed at a position farthest from first capacitor element 2a.

First external terminal 51 has a substantially L shape in side view. That is, first external terminal 51 protrudes upward from first connecting part 61 and then protrudes rearward.

### «First Connecting Part»

As illustrated in FIG. 3, first connecting part 61 connects first internal terminals 41 with first external terminal 51. First connecting part 61 extends in a direction (left-right direction) in which the plurality of capacitor elements 2 are aligned.

In the present exemplary embodiment, first connecting part 61 has a substantially L-shape in side view. Specifically, first connecting part 61 includes side plate 601 and bottom plate 611.

Side plate 601 is positioned at a side (a rear side in the present exemplary embodiment) of the plurality of capacitor elements 2. Side plate 601 has a thickness in the front-rear direction, a width in the up-down direction, and a flat plate shape extending in the left-right direction. The width of side plate 601 is substantially equal to a height (length in the up-down direction) of capacitor element 2. A length (left-right direction) of side plate 601 is substantially equal to a product of a width (left-right direction) of capacitor element 2 and the number (four in the present exemplary embodiment) of capacitor elements 2.

First external terminal 51 protrudes upward from an upper end of side plate 601 at a right side position with respect to a center in the left-right direction.

Bottom plate 611 is positioned below the plurality of capacitor elements 2. Bottom plate 611 has a thickness in the up-down direction, a width in the front-rear direction, and a flat plate shape extending in the left-right direction. A width of bottom plate 611 is substantially equal to a half of a length (length in the front-rear direction) of capacitor element 2 (see FIG. 5). A length (left-right direction) of bottom plate 611 is equal to the length (left-right direction) of side plate 601.

Bottom plate 611 protrudes forward from a lower end of side plate 601. The plurality of first internal terminals 41 protrude forward from a front end of bottom plate 611.

### <Second Bus Bar>

Second bus bar 32 is also a conductive member similarly to first bus bar 31. A material of second bus bar 32 is similar to the material of first bus bar 31.

Second bus bar 32 does not come into direct contact with first bus bar 31. As illustrated in FIG. 3, second bus bar 32 includes second internal terminals 42, second external terminal 52, and second connecting part 62. Second internal terminals 42, second external terminal 52, and second connecting part 62 are integrated. Second bus bar 32 is also formed by, for example, appropriately punching and bending a metal plate.

### «Second Internal Terminal»

Second internal terminals 42 have a one-to-one correspondence with capacitor elements 2. That is, in second bus bar 32, a number of second internal terminals 42 is equal to a number of capacitor elements 2. Second internal terminals 42 protrude forward from second connecting part 62. Second internal terminals 42 are connected to second electrodes 22 by, for example, soldering (see FIGS. 2 and 4).

### «Second External Terminal»

Second external terminal 52 is configured to be connected to an external device (not illustrated). Specific examples of the external device are as described above.

Second external terminal 52 is disposed at a left side of first external terminal 51 (see FIGS. 4 and 5). Second external terminal 52 has a substantially L-shape in side view. That is, second external terminal 52 protrudes upward from second connecting part 62 and then protrudes rearward.

### «Second Connecting Part»

As illustrated in FIG. 3, second connecting part 62 connects second internal terminals 42 with second external terminal 52. Second connecting part 62 extends in the direction (left-right direction) in which the plurality of capacitor elements 2 are aligned.

In the present exemplary embodiment, second connecting part 62 includes side plate 602. Side plate 602 is positioned at a side (a rear side in the present exemplary embodiment) of the plurality of capacitor elements 2. Side plate 602 has a thickness in the front-rear direction, a width in the up-down direction, and a flat plate shape extending in the left-right direction. A width (up-down direction) and length (left-right direction) of side plate 602 of second connecting part 62 are substantially equal to the width (up-down direction) and the length (left-right direction) of side plate 601 of first connecting part 61.

The plurality of second internal terminals 42 protrude forward from an upper end of side plate 602. Second external terminal 52 protrudes upward from an upper end of side plate 602 at a right side position with respect to a center in the left-right direction.

Side plate 602 is interposed between the plurality of capacitor elements 2 and side plate 601 of first connecting part 61 in the front-rear direction. However, side plate 602 of second connecting part 62 does not come into direct contact with side plate 601 of first connecting part 61.

Second connecting part 62 has a plurality of (four in the present exemplary embodiment) through-holes 60. Specifically, the plurality of through-holes 60 penetrate side plate 602 in the front-rear direction. Through-holes 60 have a one-to-one correspondence with capacitor elements 2. That is, in second connecting part 62, a number of through-holes 60 is equal to a number of capacitor elements 2. In a case where four through-holes 60 are distinguished from each other, these through-holes 60 may be referred to as first through-hole 60a, second through-hole 60b, third through-hole 60c, and fourth through-hole 60d in order from left to right.

### <Insulating Member>

The insulating member is a member having an electrical insulation property. A material of insulating member 7 is not particularly limited, and examples thereof include polyphenylene sulfide (PPS).

Insulating member 7 is interposed between side plate 601 of first connecting part 61 and second connecting part 62. Specifically, insulating member 7 is interposed between side plate 601 of first connecting part 61 and side plate 602 of second connecting part 62 in the front-rear direction.

Insulating member 7 includes main body 700 and a plurality of (four in the present exemplary embodiment) positioning parts 70. Main body 700 and the plurality of positioning parts 70 are integrated.

Main body 700 has a thickness in the front-rear direction, a width in the up-down direction, and a flat plate shape extending in the left-right direction. A width (up-down direction) and a length (left-right direction) of main body 700 are substantially equal to the width (up-down direction) and the length (left-right direction) of side plate 601. Side plate 601 of first connecting part 61 faces the plurality of capacitor elements 2 with main body 700 of insulating member 7 and side plate 602 of second connecting part 62 interposed therebetween.

Positioning parts 70 protrude forward from a front surface of main body 700. Positioning parts 70 penetrate through-holes 60 and abut on capacitor elements 2 (see FIG. 4). As described above, capacitor elements 2 abut on distal ends of positioning parts 70, and thus, capacitor elements 2 are positioned in the front-rear direction.

Positioning parts 70 have a one-to-one correspondence with through-holes 60 of second bus bar 32 and a one-to-one correspondence with capacitor elements 2. That is, in insulating member 7, a number of positioning parts 70 is equal to a number of capacitor elements 2.

In a case where four positioning parts 70 are distinguished from each other, these positioning parts 70 may be referred to as first positioning part 70a, second positioning part 70b, third positioning part 70c, and fourth positioning part 70d in order from left to right. First positioning part 70a, second positioning part 70b, third positioning part 70c, and fourth positioning part 70d correspond to first through-hole 60a, second through-hole 60b, third through-hole 60c, and fourth through-hole 60d, respectively. First positioning part 70a, second positioning part 70b, third positioning part 70c, and fourth positioning part 70d correspond to first capacitor element 2a, second capacitor element 2b, third capacitor element 2c, and fourth capacitor element 2d, respectively.

In the present exemplary embodiment, when four positioning parts 70 are aligned in order from a positioning part having a shorter protrusion length (front-rear direction), first positioning part 70a, second positioning part 70b, third positioning part 70c, and fourth positioning part 70d are aligned in this order (see FIGS. 4 and 5). Note that, the protrusion lengths of third positioning part 70c and fourth positioning part 70d may be the same.

### <Positional Relationship Among Plurality of Capacitor Elements>

Next, a positional relationship among the plurality of capacitor elements 2 will be described.

The plurality of capacitor elements 2 are aligned in the left-right direction, but are shifted in the front-rear direction (see FIGS. 4 and 5). Note that, the plurality of capacitor elements 2 are not shifted in the up-down direction.

Specifically, capacitor element 2 disposed at a position farthest from first external terminal 51 in the left-right direction among the plurality of capacitor elements 2 is disposed at the position closest to side plate 601 of first connecting part 61 in the front-rear direction. Here, when capacitor element 2 is disposed at the position farthest from first external terminal 51, a current path from capacitor element 2 to first external terminal 51 is the longest. Further, when capacitor element 2 is disposed at the position closest to side plate 601 of first connecting part 61, a distance (a distance along the front-rear direction) from side plate 601 to capacitor element 2 is the shortest. Note that, the distance from side plate 601 to capacitor element 2 can be adjusted by the protrusion length (a length in the front-rear direction) of positioning part 70 of insulating member 7.

That is, in the present exemplary embodiment, first capacitor element 2a disposed at the position farthest from first external terminal 51 in the left-right direction among four capacitor elements 2 is disposed at the position closest to side plate 601 of first connecting part 61 in the front-rear direction.

Further, capacitor element 2 disposed at a position closest to first external terminal 51 in the left-right direction among the plurality of capacitor elements 2 is disposed at a position farthest from side plate 601 of first connecting part 61 in the front-rear direction. Here, when capacitor element 2 is disposed at the position closest to first external terminal 51, the current path from capacitor element 2 to first external terminal 51 is the shortest. Further, when capacitor element 2 is disposed at the position farthest from side plate 601 of first connecting part 61, the distance (the distance along the front-rear direction) from side plate 601 to capacitor element 2 is the longest.

That is, in the present exemplary embodiment, fourth capacitor element 2d disposed at the position closest to first external terminal 51 in the left-right direction among four capacitor elements 2 is disposed at the position farthest from side plate 601 of first connecting part 61 in the front-rear direction (see FIGS. 4 and 5).

Preferably, as the distance between one capacitor element among the plurality of capacitor elements 2 and first external terminal 51 in the left-right direction becomes shorter, the distance between the one capacitor element and side plate 601 of first connecting part 61 in the front-rear direction becomes longer. That is, in the present exemplary embodiment, the distance (current path) from first external terminal 51 is shorter in the front-rear direction in the order of first capacitor element 2a, second capacitor element 2b, third capacitor element 2c, and fourth capacitor element 2d. Preferably, first capacitor element 2a, second capacitor element 2b, third capacitor element 2c, and fourth capacitor element 2d are located to have longer distances (the distances along the front-rear direction) from side plate 601 of first connecting part 61 in this order. Note that, the distance between third capacitor element 2c and side plate 601 of first connecting part 61 may be equal to the distance between fourth capacitor element 2d and side plate 601 of first connecting part 61.

Further, in the present exemplary embodiment, the plurality of capacitor elements 2 are aligned in the first direction (left-right direction) with flat surfaces 23 and 24 facing each other (see FIGS. 4 and 5). That is, among two capacitor elements 2 adjacent to each other in the left-right direction, flat surface 23 of one capacitor element 2 and flat surface 24 of other capacitor element 2 face each other.

### <Case>

As illustrated in FIG. 1, case 8 houses the plurality of capacitor elements 2. In the present exemplary embodiment, case 8 is opened upward.

Case 8 has an electrical insulation property. A material of case 8 is not particularly limited, and examples thereof include polyphenylene sulfide (PPS), polybutylene terephthalate (PBT), and an epoxy resin (EP).

### <Seal Portion>

As illustrated in FIG. 1, case 8 is filled with seal portion 9. Specifically, seal portion 9 is filled in a gap between an inner surface of case 8 and capacitor element 2. Further, the plurality of capacitor elements 2, first bus bar 31, second bus bar 32, and insulating member 7 are buried in seal portion 9 except for first external terminal 51 of first bus bar 31, second external terminal 52 of second bus bar 32, and a part of insulating member 7. As described above, seal portion 9 seals the plurality of capacitor elements 2. First external terminal 51 of first bus bar 31 and second external terminal 52 of second bus bar 32 are led out from seal portion 9 to an outside.

Seal portion 9 is a cured product of a resin having an electrical insulation property. The resin includes, for example, a thermosetting resin, a photocurable resin, and the like. The resin is not particularly limited, and examples thereof include an epoxy resin (EP).

### <Effects>

In the first exemplary embodiment, the variations in heat generation of the plurality of capacitor elements 2 can be reduced. The reason for this is considered as follows.

In the present exemplary embodiment, capacitor element 2 (first capacitor element 2a) disposed at the position farthest from first external terminal 51 in the left-right direction among the plurality of capacitor elements 2 is disposed at the position closest to side plate 601 of first connecting part 61 in the front-rear direction (see FIGS. 4 and 5).

As described above, since first capacitor element 2a is disposed at the position farthest from first external terminal 51, the inductance generated by the current path from first external terminal 51 to first capacitor element 2a increases. As described above, the inductance increases as the current path increases.

In the present embodiment, first capacitor element 2a is disposed at the position closest to side plate 601 of first connecting part 61. Thus, a magnetic flux generated by a current flowing through first capacitor element 2a and a magnetic flux generated by a current flowing through side plate 601 of first connecting part 61 cancel each other. The magnetic fluxes cancel each other, and thus, an effect of lowering the inductance can be obtained. Thus, the inductances of all the current paths of four capacitor elements 2 can be easily matched.

As a result, the resonance frequency derived from the electrostatic capacity of capacitor element 2 and the inductance of the current path for capacitor element 2 can be matched in the plurality of capacitor elements 2. As a result, since a difference in impedance and phase is hardly generated in the entire frequency range, it is possible to suppress variation in current divided and flowing through each capacitor element 2.

Accordingly, according to the present exemplary embodiment, the variations in heat generation of the plurality of capacitor elements 2 can be reduced.

Further, in the present exemplary embodiment, capacitor element 2 (fourth capacitor element 2d) disposed at the position closest to first external terminal 51 in the left-right direction among the plurality of capacitor elements 2 is disposed at the position farthest from side plate 601 of first connecting part 61 in the front-rear direction. As a result, the variations in heat generation of the plurality of capacitor elements 2 can be further reduced.

Further, preferably, as the distance between one of the plurality of capacitor elements 2 and first external terminal 51 in the left-right direction becomes shorter, the distance between one of capacitor elements 2 and side plate 601 of first connecting part 61 in the front-rear direction becomes longer. As a result, a degree of cancellation of the magnetic fluxes can be changed in accordance with the magnitude of the inductance generated by the current path. Thus, the inductances from first external terminal 51 to capacitor elements 2 can be matched, and the variations in heat generation of the plurality of capacitor elements 2 can be further reduced.

Further, in the present exemplary embodiment, since the plurality of capacitor elements 2 are aligned in the first direction (left-right direction) so that flat surface 23 of one capacitor element 2 and flat surface 24 of another capacitor element 2 face each other, the plurality of capacitor elements 2 fit well. That is, a dead space is hardly formed between two adjacent capacitor elements 2.

Further, in the present exemplary embodiment, insulating member 7 is interposed between side plate 601 of first connecting part 61 and second connecting part 62. Specifically, insulating member 7 is interposed between side plate 601 and side plate 602. As a result, for example, when a thickness or the like of insulating member 7 is adjusted as necessary, side plate 601 and side plate 602 can be brought closer to each other. Accordingly, the inductance can be reduced.

Further, as illustrated in FIG. 1, when capacitor 1 further includes case 8 and seal portion 9, moisture resistance can be improved. That is, seal portion 9 can suppress entry of moisture into capacitor element 2.

### (2) Second Exemplary Embodiment

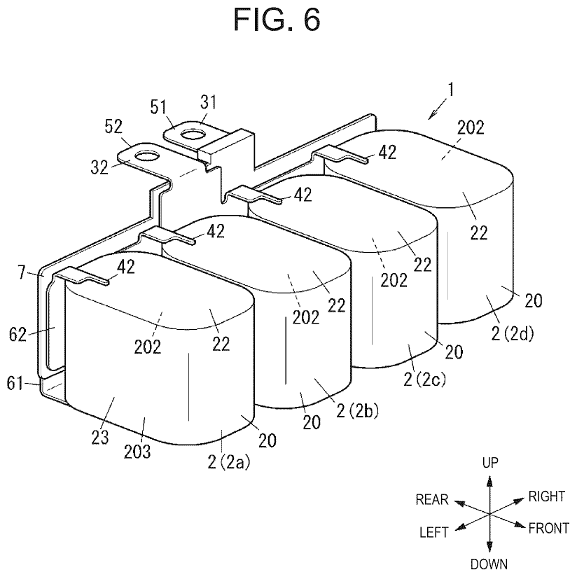

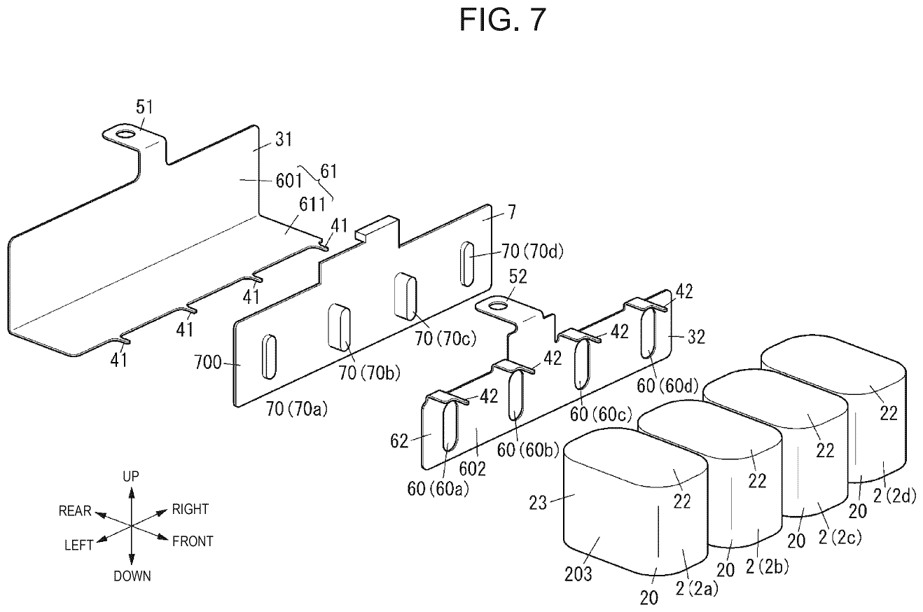

Next, capacitor 1 according to a second exemplary embodiment will be described with reference to FIGS. 6 to 9. In the second exemplary embodiment, the same configuration elements as those in the first exemplary embodiment are denoted by the same reference numerals as those in the first exemplary embodiment, and a detailed description thereof may be omitted.

The second exemplary embodiment is different from the first exemplary embodiment in that first external terminal 51 of first bus bar 31 and second external terminal 52 of second bus bar 32 are disposed substantially at the center in the left-right direction.

### <Positional Relationship Among Plurality of Capacitor Elements>

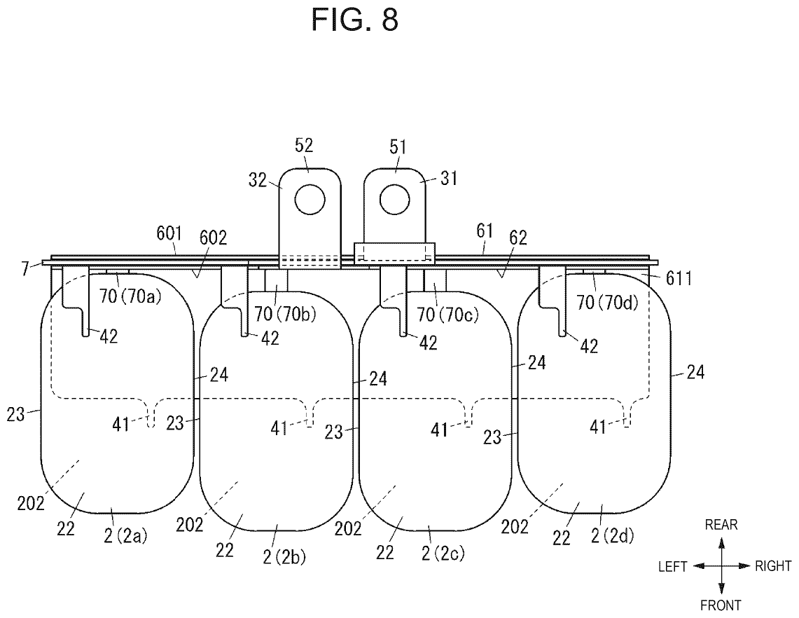

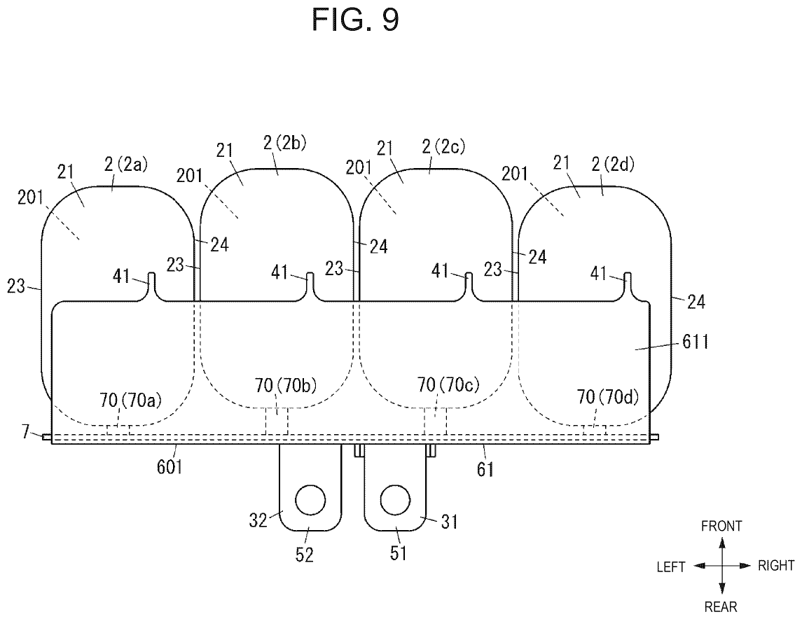

In the present exemplary embodiment, capacitor element 2 disposed at the position closest to first external terminal 51 in the left-right direction among the plurality of capacitor elements 2 is also disposed at the position farthest from side plate 601 of first connecting part 61 in the front-rear direction. That is, in the present exemplary embodiment, third capacitor element 2c disposed at the position closest to first external terminal 51 in the left-right direction among four capacitor elements 2 is disposed at the position farthest from side plate 601 of first connecting part 61 in the front-rear direction (see FIGS. 8 and 9). That is, among four positioning parts 70, the protrusion length of third positioning part 70c is the longest.

Note that, similarly to third capacitor element 2c, second capacitor element 2b at a left of third capacitor element 2c may also be disposed at the position farthest from side plate 601 of first connecting part 61 in the front-rear direction. That is, the protrusion length of second positioning part 70b may be the same as the protrusion length of third positioning part 70c.

Further, capacitor element 2 disposed at the position farthest from first external terminal 51 in the left-right direction among the plurality of capacitor elements 2 is disposed at the position closest to side plate 601 of first connecting part 61 in the front-rear direction. That is, in the present exemplary embodiment, first capacitor element 2a disposed at the position farthest from first external terminal 51 in the left-right direction among four capacitor elements 2 is disposed at the position closest to side plate 601 of first connecting part 61 in the front-rear direction. That is, among four positioning parts 70, the protrusion length of first positioning part 70a is the shortest.

Note that, similarly to first capacitor element 2a, fourth capacitor element 2d at a right end may also be disposed at the position closest to side plate 601 of first connecting part 61 in the front-rear direction. That is, the protrusion length of fourth positioning part 70d may be the same as the protrusion length of first positioning part 70a.

### <Effects>

The second exemplary embodiment also has the same effects as the first exemplary embodiment. Accordingly, the position of first external terminal 51 of first bus bar 31 is not limited in the left-right direction of capacitor 1. That is, the distance from side plate 601 may be determined for each of the plurality of capacitor elements 2 in accordance with the position of first external terminal 51 in the left-right direction (the length of the current path with first external terminal 51).

### (3) Third Exemplary Embodiment

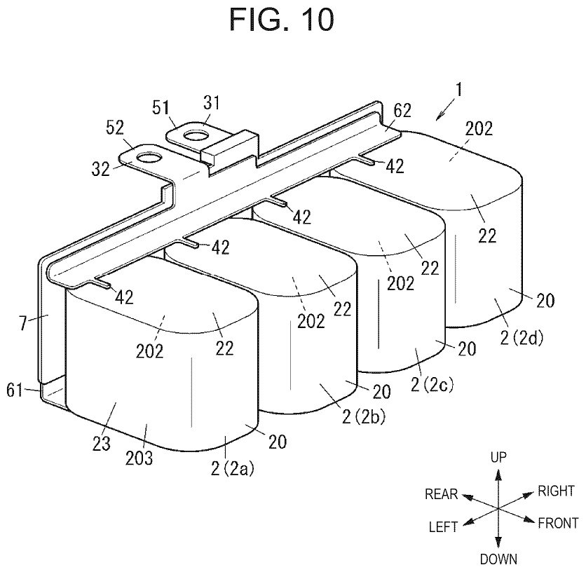

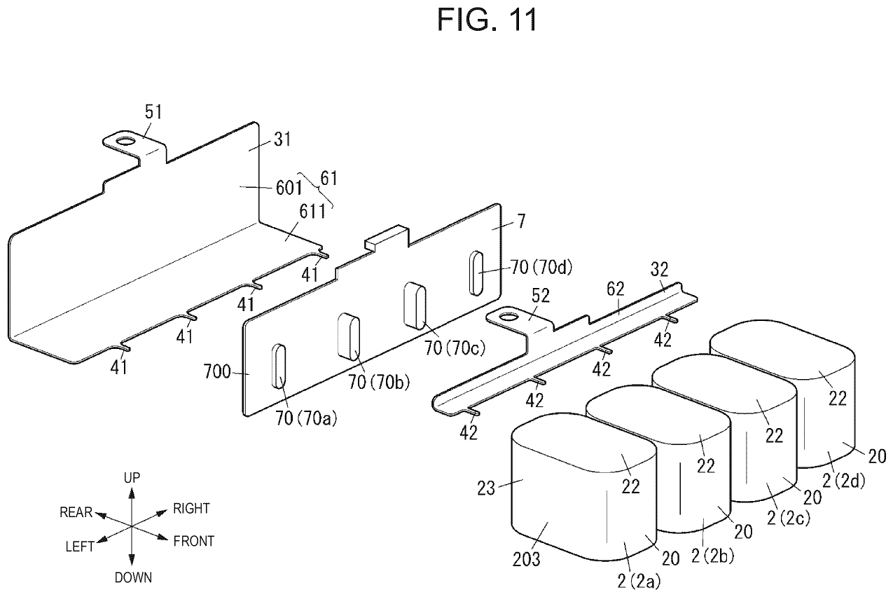

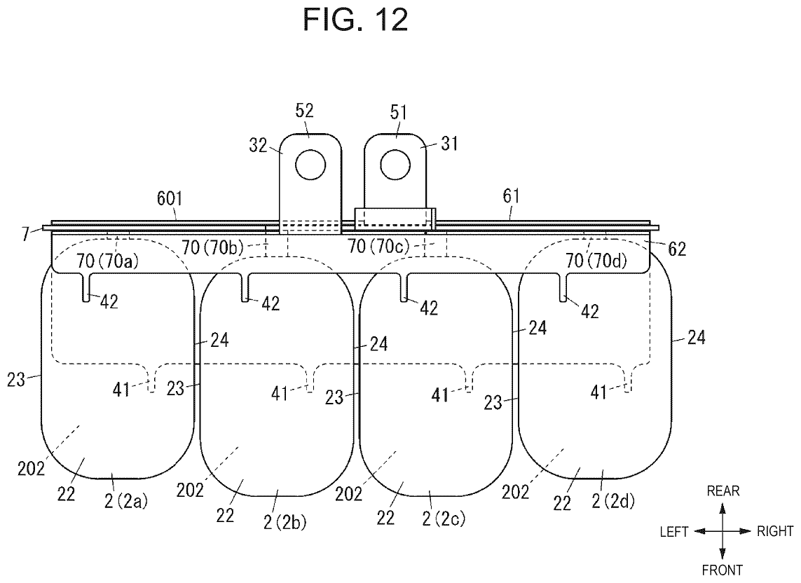

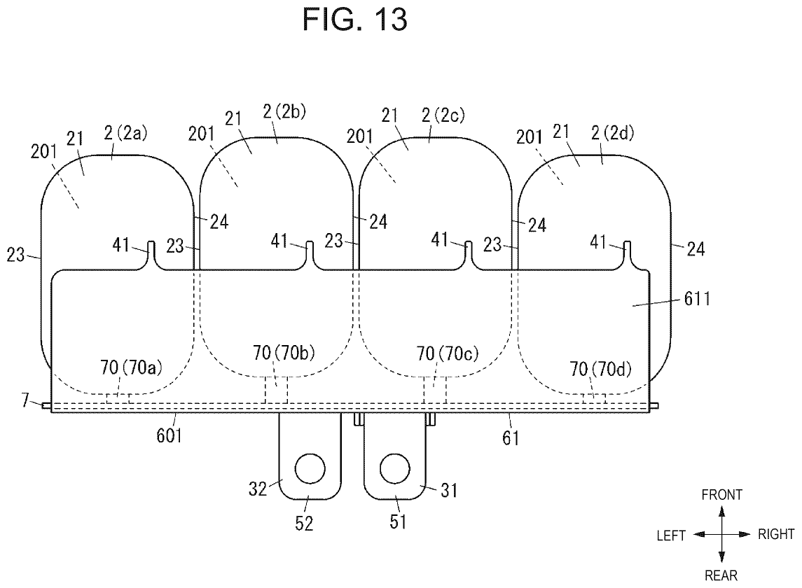

Next, capacitor 1 according to a third exemplary embodiment will be described with reference to FIGS. 10 to 13. In the third exemplary embodiment, the same configuration elements as those in the first to second exemplary embodiments are denoted by the same reference numerals as those in the first and second exemplary embodiments, and a detailed description thereof may be omitted.

The third exemplary embodiment is different from the second exemplary embodiment in that second connecting part 62 of second bus bar 32 does not include side plate 602.

### «Second Connecting Part»

Second connecting part 62 has a substantially L-shape in side view, and extends in the direction (left-right direction) in which the plurality of capacitor elements 2 are aligned. However, second connecting part 62 of the present exemplary embodiment does not include side plate 602 of the first and second exemplary embodiments. Thus, second connecting part 62 of the present exemplary embodiment does not have through-holes 60 of the first and second exemplary embodiments.

Second connecting part 62 of the present exemplary embodiment is present above the plurality of capacitor elements 2, and is not present behind the plurality of capacitor elements 2. As a result, side plate 601 of first connecting part 61 faces the plurality of capacitor elements 2 with main body 700 of insulating member 7 interposed therebetween.

### <Effects>

The third exemplary embodiment also has the same effects as the first exemplary embodiment. As described above, even though second connecting part 62 of second bus bar 32 does not include side plate 602, the variations in heat generation of the plurality of capacitor elements 2 can be reduced.

### 3. Modifications

In the first to third exemplary embodiments, capacitor 1 includes four capacitor elements 2, but the number of capacitor elements 2 is not particularly limited as long as the capacitor includes two or more capacitor elements 2.

Similarly to capacitor 1 according to the first exemplary embodiment, capacitor 1 according to the second to third exemplary embodiments may further include case 8 and seal portion 9.

### 4. Aspects

As is apparent from the above exemplary embodiments and modifications, the present disclosure includes the following aspects. In the following description, reference numerals are given in parentheses only to clarify the correspondence relationship with the exemplary embodiments.

A first aspect is capacitor (1) including a plurality of capacitor elements (2) aligned in a first direction, first bus bar (31), and second bus bar (32). Each of the plurality of capacitor elements (2) includes element body (20), first electrode (21) disposed at one end of element body (20), and second electrode (22) disposed at another end of element body (20). First bus bar (31) includes first internal terminal (41) connected to first electrode (21), first external terminal (51) to be connected to an external device, and first connecting part (61) that connects first internal terminal (41) with first external terminal (51), first connecting part (61) extending in the first direction. First connecting part (61) includes side plate (601) positioned at a side of the plurality of capacitor elements (2) in a second direction orthogonal to the first direction. Second bus bar (32) includes second internal terminal (42) connected to second electrode (22), second external terminal (52) to be connected to the external device, and second connecting part (62) that connects second internal terminal (42) with second external terminal (52). Capacitor element (2) disposed at a position farthest from first external terminal (51) in the first direction among the plurality of capacitor elements (2; 2a) is disposed at a position closest to side plate (601) of first connecting part (61) in the second direction among the plurality of capacitor elements (2; 2a).

According to this aspect, the variations in heat generation of the plurality of capacitor elements (2) can be reduced.

A second aspect is capacitor (1) based on the first aspect. In the second aspect, capacitor element (2; 2d) disposed at a position closest to first external terminal (51) in the first direction among the plurality of capacitor elements (2) is disposed at a position farthest from side plate (601) of first connecting part (61) in the second direction among the plurality of capacitor elements (2).

According to this aspect, the variations in heat generation of the plurality of capacitor elements (2) can be further reduced.

A third aspect is capacitor (1) based on the first or second aspect. In the third aspect, as a distance between first external terminal (51) and one capacitor element among the plurality of capacitor elements (2) in the first direction becomes shorter, a distance between one capacitor element (2) and side plate (601) of first connecting part (61) in the second direction becomes longer.

According to this aspect, the variations in heat generation of the plurality of capacitor elements (2) can be further reduced.

A fourth aspect is capacitor (1) based on any one of the first to third aspects. In the fourth aspect, element body (20) includes two flat surfaces (23 and 24) parallel to each other. Two capacitor elements adjacent to each other in the first direction among the plurality of capacitor elements (2) are disposed so that one of two flat surfaces (23 and 24) in one of the two capacitor elements faces a corresponding one of the two flat surfaces in another one of the two capacitor elements in the first direction.

According to this aspect, the plurality of capacitor elements (2) fit well.

A fifth aspect is capacitor (1) based on any one of the first to fourth aspects. In the fifth aspect, capacitor (1) further includes insulating member (7) disposed between second connecting part (62) and side plate (601) of first connecting part (61).

According to this aspect, the inductance can be reduced.

A sixth aspect is capacitor (1) based on any one of the first to fifth aspects. In the sixth aspect, capacitor (1) further includes case (8) that houses the plurality of capacitor elements (2), and seal portion (9) that seals the plurality of capacitor elements (2).

According to this aspect, the moisture resistance can be improved.

What is claimed is:

1. A capacitor comprising:
a plurality of capacitor elements aligned in a first direction;
a first bus bar; and
a second bus bar,
wherein:
each of the plurality of capacitor elements includes an element body, a first electrode disposed at one end of the element body, and a second electrode disposed at another end of the element body,
the first bus bar includes a first internal terminal connected to the first electrode, a first external terminal to be connected to an external device, and a first connecting part that connects the first internal terminal with the first external terminal, the first connecting part extending in the first direction,
the first connecting part includes a side plate positioned at a side of the plurality of capacitor elements in a second direction orthogonal to the first direction,
the second bus bar includes a second internal terminal connected to the second electrode, a second external terminal to be connected to the external device, and a second connecting part that connects the second internal terminal with the second external terminal, and
a capacitor element disposed at a position farthest from the first external terminal in the first direction among the plurality of capacitor elements is disposed at a position closest to the side plate of the first connecting part in the second direction among the plurality of capacitor elements.

2. The capacitor according to claim 1, wherein
a capacitor element disposed at a position closest to the first external terminal in the first direction among the plurality of capacitor elements is disposed at a position farthest from the side plate of the first connecting part in the second direction among the plurality of capacitor elements.

3. The capacitor according to claim 2, wherein
as a distance between the first external terminal and one capacitor element among the plurality of capacitor elements in the first direction becomes shorter, a distance between the one capacitor element and the side plate of the first connecting part in the second direction becomes longer.

4. The capacitor according to claim 1, wherein:
the element body has two flat surfaces parallel to each other, and
two capacitor elements adjacent to each other in the first direction among the plurality of capacitor elements are disposed so that one of the two flat surfaces in one of the two capacitor elements faces a corresponding one of the two flat surfaces in another one of the two capacitor elements in the first direction.

5. The capacitor according to claim 1, further comprising an insulating member disposed between the second connecting part and the side plate of the first connecting part.

6. The capacitor according to claim 1, further comprising a case that houses the plurality of capacitor elements, and a seal portion that seals the plurality of capacitor elements.
